(19) United States
(12) Patent Application Publication
(10) Pub. No.: US 2021/0015054 A1
(43) Pub. Date: Jan. 21, 2021

(54) PLANTING PANEL FOR VERTICAL GARDEN

(71) Applicant: Soraphop HOMSRI, Chonburi (TH)

(72) Inventor: Soraphop HOMSRI, Chonburi (TH)

(21) Appl. No.: 17/044,228

(22) PCT Filed: Apr. 4, 2019
(86) PCT No.: PCT/TH2019/000007

§ 371 Date: Sep. 30, 2020

(30) Foreign Application Priority Data
Apr. 4, 2018 (TH) 1801002087

(51) Int. Cl. A01G 9/02

(52) U.S. Cl. CPC A01G 9/025; A01G 9/028

(57) ABSTRACT

A vertical garden planting panel includes single level and single hole. There are a upper hole (G) and a lower hole (E) connecting each other with soil. The upper hole (G) provides bigger than the lower hole (E), which can form a space for planting. Two side holes connect to a male drainage pipe (M) of a water box. A spur (J) at the lower end connects with the vertical garden planting panel strongly. A water retarding basin (R) uses for water collection and delays the speed of water flowing. There are also including a single level double holes vertical garden planting panel, a multiple levels single hole vertical garden planting panel, a multiple levels double holes vertical garden planting panel, a screen box and a water box. These vertical garden planting panels make planting easier and cost lower.

### TECHNICAL FIELD

This invention is the architecture related to the planting panel using for the vertical garden which contains the soil inside, able to plant the ornamental plant in vertical planting like the natural planting and using for building area decoration.

### BACKGROUND ART

The city has less area, with much population and focus on the green environment such as Singapore try to find out the area for planting in limited area using the vertical line or the vertical garden. The objective of vertical garden is the increasing area of planting in limited area, where it could not plant in the horizontal line and should plant by other method for the improvement of environmental, decoration the place, enhancing the image for the building place and decreasing temperature of surrounding area. From the research report of international found that the vertical garden solved this problem, it will decrease temperature, then safe electrical energy for air-condition. Presently, the vertical garden will be popular method in various countries which implemented the vertical garden in supermarket, office, hotel, resort, public park and the residences, condominium, house etc. But, the limited of vertical garden depend on the planting was not the natural way, the complexity of vertical garden system. The high cost for construction and maintenance of vertical garden with the expert as the supervisor. The vertical garden is not the permanent garden. Therefore, the limited of vertical garden development was conducted. In Thailand, the vertical garden just start, not well-known. The vertical garden divided into 4 systems as follows;

1. Vertical garden as Hanging Plant Pot system and Ready Plant Pot System. The small plant or shrub will plant in plant pot. Then holding or hanging pot on the wall or structure. The plant pot will arrange and connect as the large area such as Bangkok Metropolis vertical garden or the vertical garden in some residence. On the other hand, the ready plant pot has the pocket for planting or the channel for holding the pot. Majority of them use the single pot for 1 tree and the series of pot provide the pocket for the plant such as the series of plant for example SCG, Modular Green Hive, and other vertical garden ready plat pot of various brands. This vertical garden system is the easy planting. The general holding pot will be connecting in various line and level as the group, able to plant more tree in small area, able to decorate the tree in different shape of leaves and different color. The advantage of this vertical garden system is the light weight material, easy to setting, easy to remove and change the plant and the price is not expensive. The disadvantage of the pot system is the planting area is each pot is separate planting, not continuous planting area as the natural way. The maintenance of the tree must be carefully applied one by one because watering and fertilizer could not share to other tree, automatic watering may be required to spread evenly for every plant in vertical garden area. Watering always dips out of the pot very rapidly so the plant need more watering, if water is not enough the plant could dry. And area under vertical garden and nearby will be wet with water so it could not be applied for indoor planting. Water storage tank and drainage system will be required to solve the wetting problem.

2. Vertical garden as Readymade Felt Bag System. The plant will plant in pocket of felt bag. Fell bag has single pocket bag and multiple pockets bag. The pockets will be planting area of multiple pocket felt bag is independent of each other, not combined together as same as the readymade planting pot. The felt bag could be installed by hanging with building wall or the constructed structure. Vertical garden is easy to make by felt bag, able to change the tree when it was died. The limitation of felt bag is it could not keep the water inside. Therefore, it must often to watering. Another limitation is life time of felt and thread material is shorter than plastic pot which made from polypropylene. The large vertical garden of felt bag should bring the automatic watering system.

3. Vertical garden as Felt Wall System, it is the creative and develop system by Mr. Patrick Blance. This system is made in place method. The various layers of felt sheets will be fixed to the wall or structure on sites. The felt wall will be provided the hole for planting the tree. The watering use hydroponics system, the water pipe insert in cloth wall with automatic watering. The advantage of this vertical garden is able to design with the appropriated place. It could provide vertical garden look like natural garden. And the big vertical garden able to make. The limitation is the specific expert in gardening and expensive cost for construction of vertical garden. According to this is hydroponics system must regular maintain and pay expensive cost for the expert. If the electric shutdown or the hydroponic could not work the plant will die then the humid inspector should be set. This system has low stability. In Thailand, we found at Siam Paragon Department Store, Esplannad Department Store and Central World.

4. Vertical garden as Green Wall System. This vertical garden provide the watering and use hydroponics system as same as Felt Wall System. The application of Green Wall use the specific material for the root of tree holding as the planting replace. Green Wall System is the ready panel consist of strong plate with light weight such as fabric plate, foam or the storage water material as the coconut fiber with the top of net plate. Green Wall System provide the hole for planting and the setting will hold readymade green wall with structure. It able to hold with previous wall. The construction of this system may be more rapid than the felt wall. The limitation of Green Wall System need expert in the setting and expensive payment, must use electricity and automatic system with lower stability. The depth of material for planting has small layer, the root of tree could not extend for the growth. It could apply with only very small plant.

### PURPOSE OF INVENTION

The planting in small area is limited the large number of planting. Presently, it able to increase the area of planting by vertical garden, the various level of planting replace the ground planting as mentioned above. The vertical garden has many limitation. The construction of vertical garden and watering is very complicate and high construction cost. Vertical garden could not keep water and some system required hydroponics system. The planting area of vertical garden is not continuous, most of all they are small single pot the arranged in group both horizontal and vertical to construct large planting area which differ the natural planting area. The area is less area for root extension, the pot and felt for planting could not keep the water. Therefore, the maintenance must help the automatic system and electricity for watering. The plant in vertical garden has low stability could not be the permanent planting.

The invention of planting panel for vertical garden has developed and improved from vertical planting block as the request of patent, the request No. 1701003126 of Mr. Soraphop Homsri. The objective of invention of planting panel for vertical garden is invent the equipment applied to construct planting area for vertical garden. Vertical planting area could contain soil or planting materials inside. And the soil or the planting material inside will be continuous both vertical and horizontal, the character like the natural soil, planting panel provide the hole for planting, easier to plant the tree into it. The plant could grow as the natural way, easy to plant, easy to construct vertical garden, strong and fix continuously. No limit of sizing for planting area, there are various size of planting panel and various shape. The invention as the letter, the numbering or the symbols, and able to use for the decoration of building.

The water collection is the supplementary invention that could apply under each planting panel for vertical garden and combined together to reserve and conduct water to the next water collection and finally, the drainage system of vertical garden could be constructed both inside and outside of building. The water collection also could combine to the side wall of planting panel. The water collection will be placed under planting panel as the lowest part of any column at any level to end vertical line and it can combine to the side wall of planting panel. It will collect water from above planting panels and transfer water to adjacent planting panel. The vertical garden will start and stop at any column and any level by using water collection. Then vertical garden with any pattern such as Logo, alphabet could create for the usage of Designed or Architect.

The planting panel provide the shaper which ease to construct planting area for vertical garden. The technician or the user able to construct by themselves without the experts. The plant could plant easily in planting panel for vertical garden by himself because there is a channel for planting the plant.

The planting panel for vertical garden provide the various designs and sizes both small and large in order to selection for the appropriate size of the tree and size of planting area. The plating panel is able to construct continuously without quantity limitation, able to construct vertical garden both the small garden and the large garden, apply to public park, tourist attraction, or the world largest vertical garden. Moreover, it able to increase the area for agriculture or business with the kitchen garden in residence.

From the reason as mentioned above the objective of the inventor will development and improve the model and material using and setting including the ability of planting as the natural planting. The planting as vertical garden able to make it easily and beautifully, low cost, the good growth of tree, less maintenance and the vertical garden will be popularity, especially, the inventor focus to see green city in Thailand as vertical garden and will be the biggest vertical garden in the world.

### BRIEF DESCRIPTION OF DRAWINGS

FIG. 1 illustration of the three dimension description of single level, single path planting panel for vertical garden (1).

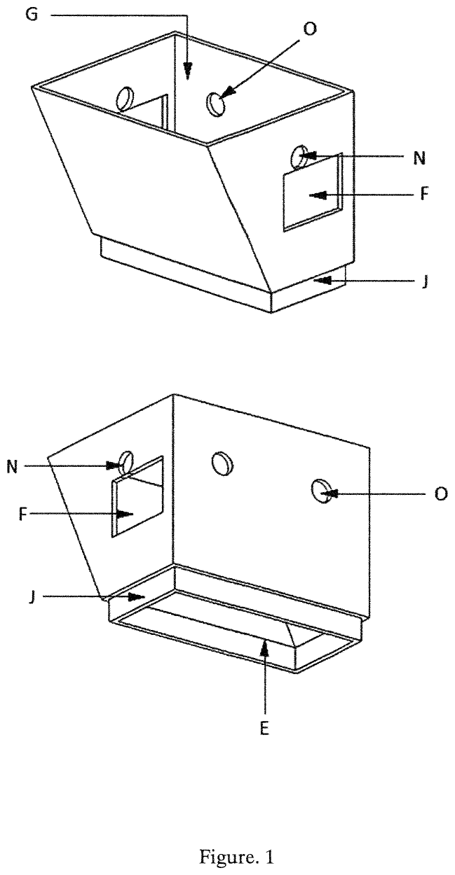

FIG. 2 illustration of the three dimension description of single level, double part planting panel for vertical garden (2) which have 2 planting path connected in horizontal.

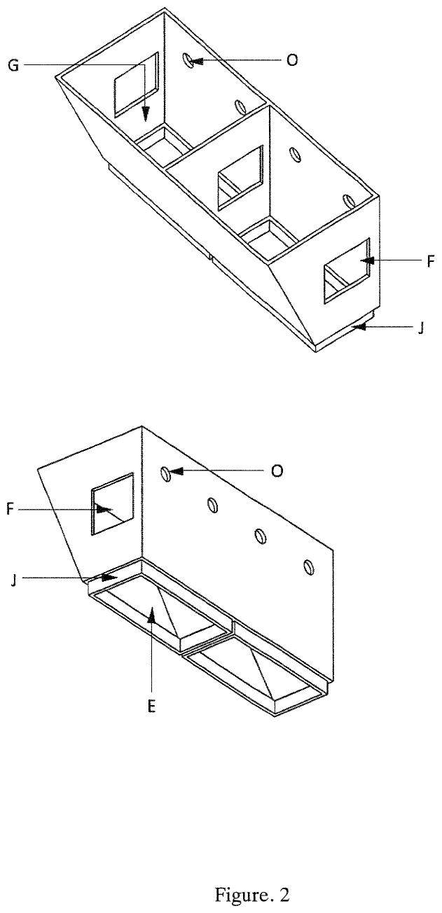

FIG. 3 illustration of the three dimension description of multiple level, single path planting panel for vertical garden (3) which have 1 planting path in horizontal and 2 or more level of planting path.

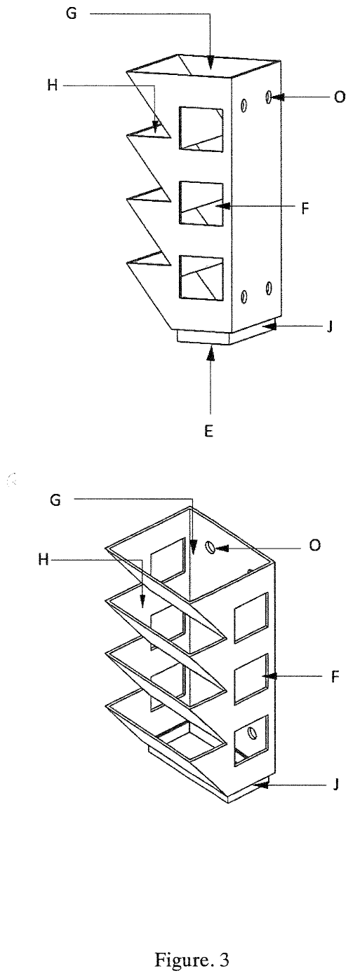

FIG. 4 illustration of the three dimension description of multiple level, double path planting panel for vertical garden (4) which have 2 planting path in horizontal and 2 or more level of planting path.

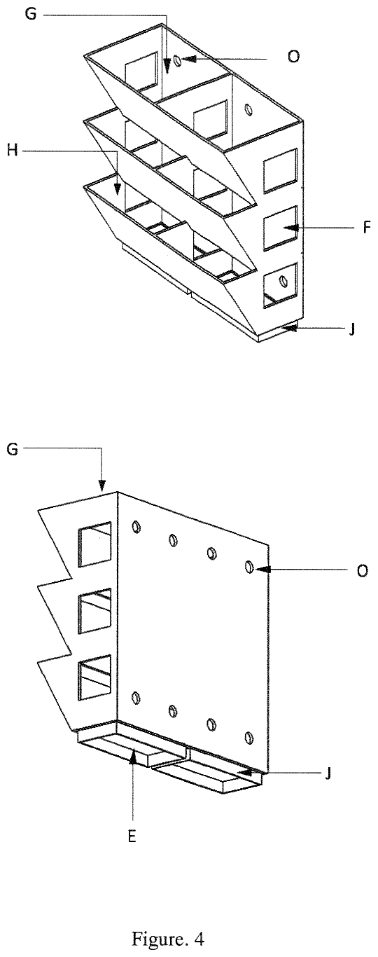

FIG. 5 illustration of the three dimension description of soil screen box (5) setting under the planting panel for vertical garden to protect the leaching of soil and drainage.

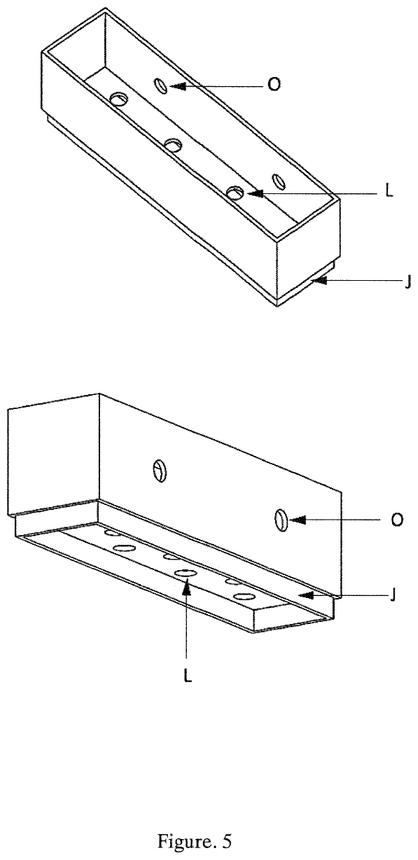

FIG. 6 illustration of the three dimension description of water collection (6) setting under soil screen box (5) or under planting panel with screen (7 to 10) for reserving water, drainage and transfer water to adjacent planting panel.

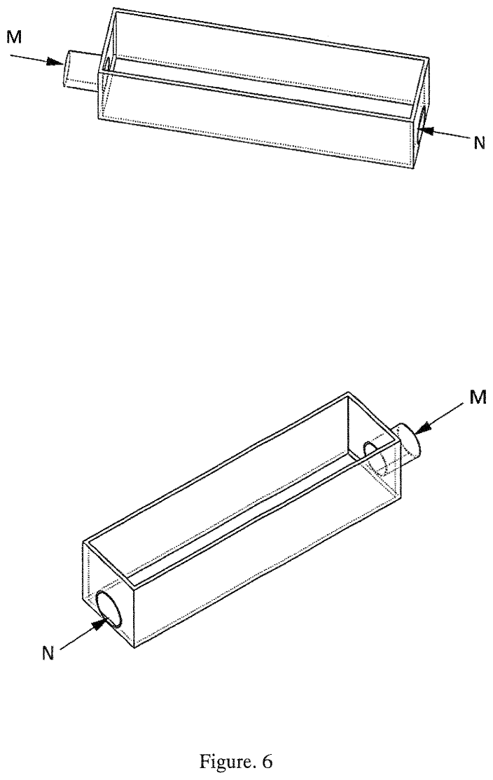

FIG. 7 illustration of the three dimension description of single level, single level, single path planting panel for vertical garden with screen (7).

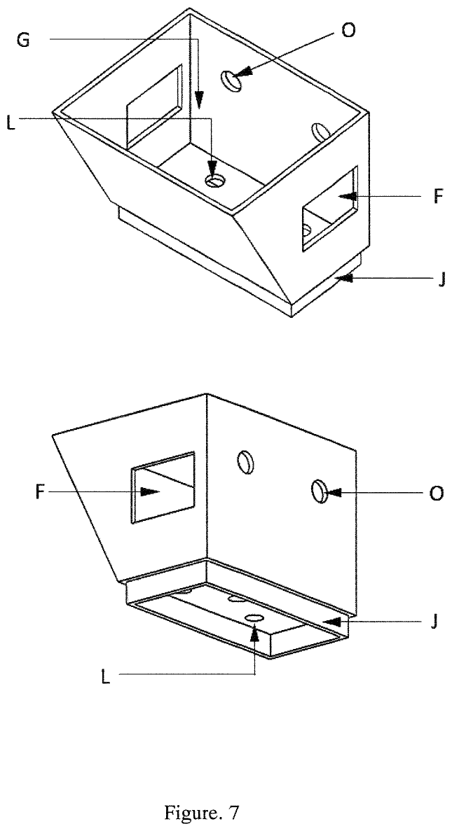

FIG. 8 illustration of the three dimension description of single level, double path planting panel for vertical garden with screen (8).

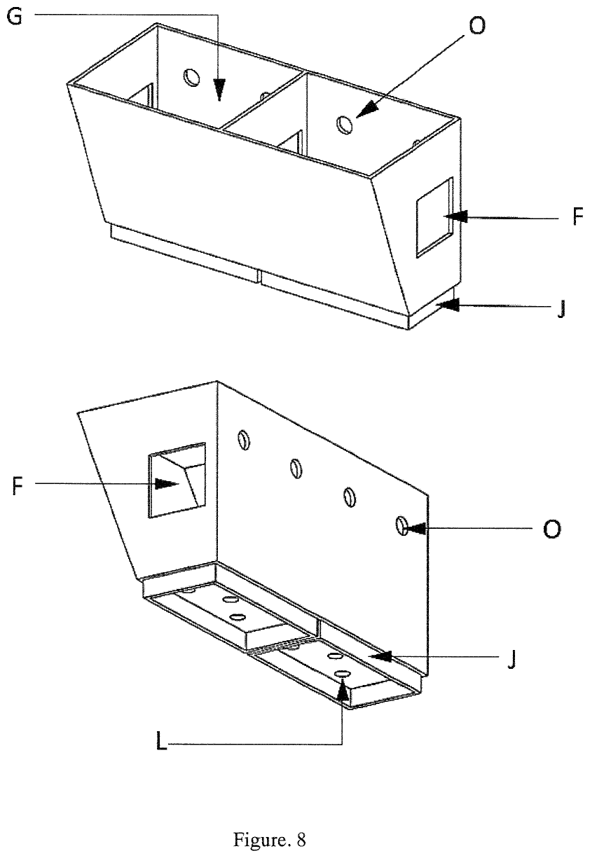

FIG. 9 illustration of the three dimension description of multiple level, single path planting panel for vertical garden with screen (9).

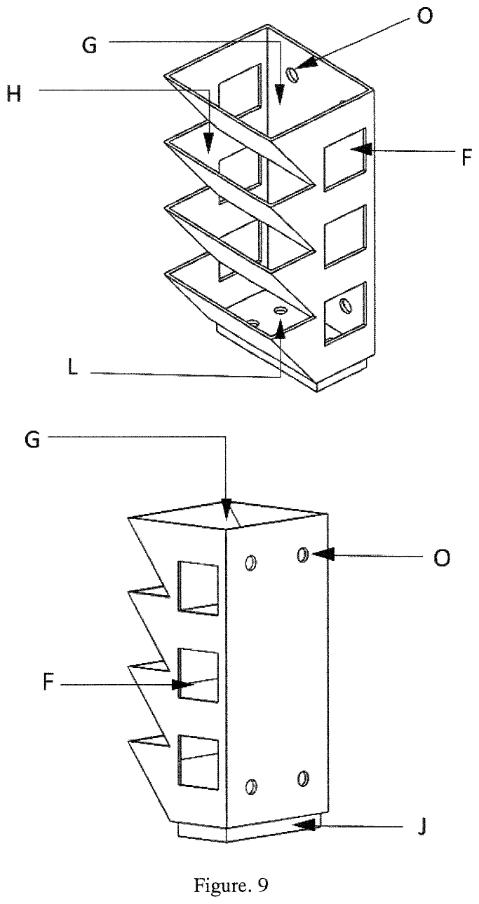

FIG. 10 illustration of the three dimension description of multiple level, double path planting panel for vertical garden with screen (10).

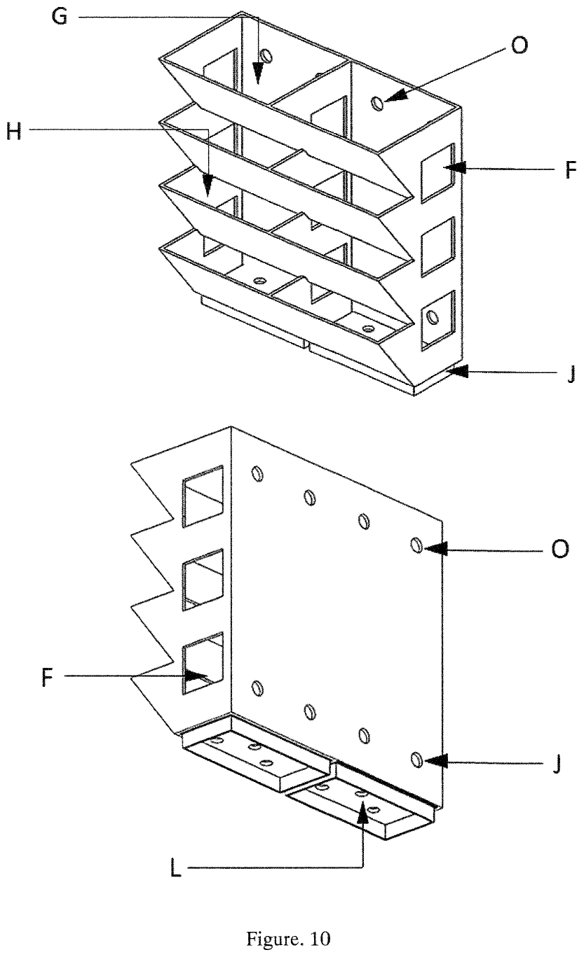

FIG. 11 illustration of the three dimension description and application of Clipping (11) using to clip side wall of 2 planting panels for vertical garden together to increase the strong of vertical garden and to set planting panel in right position.

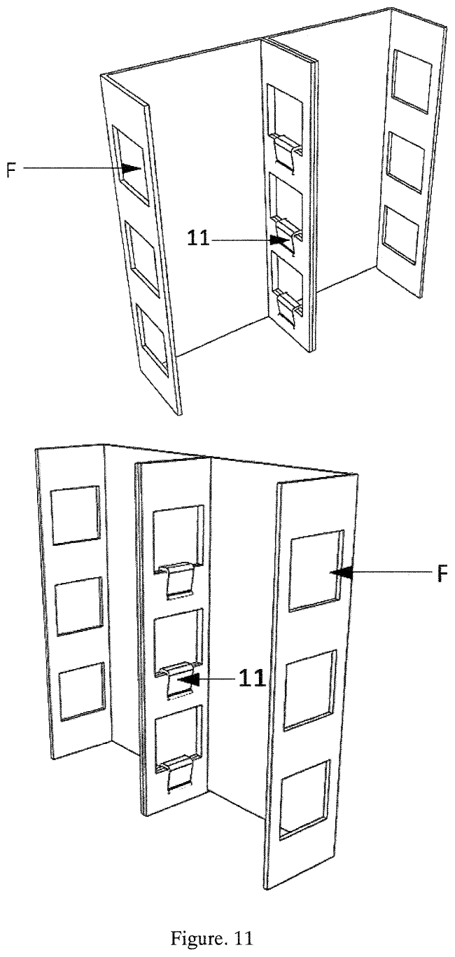

FIG. 12 illustration of the three dimension description and cross-section a fin (11 and 12) using to protect the soil flow out at the top of planting path of multiple level planting panel (3, 4, 9 and 10).

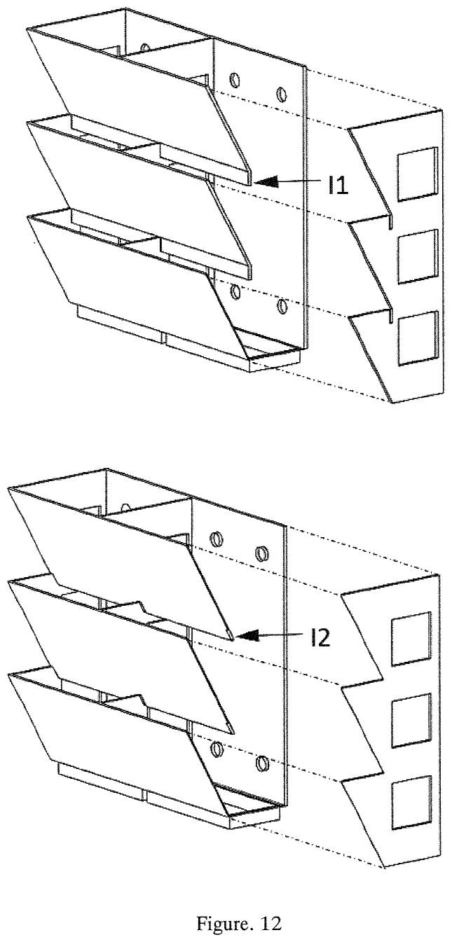

FIG. 13 illustration of the three dimension description the water retarding basin (R) of single level and single panel planting panel for vertical garden.

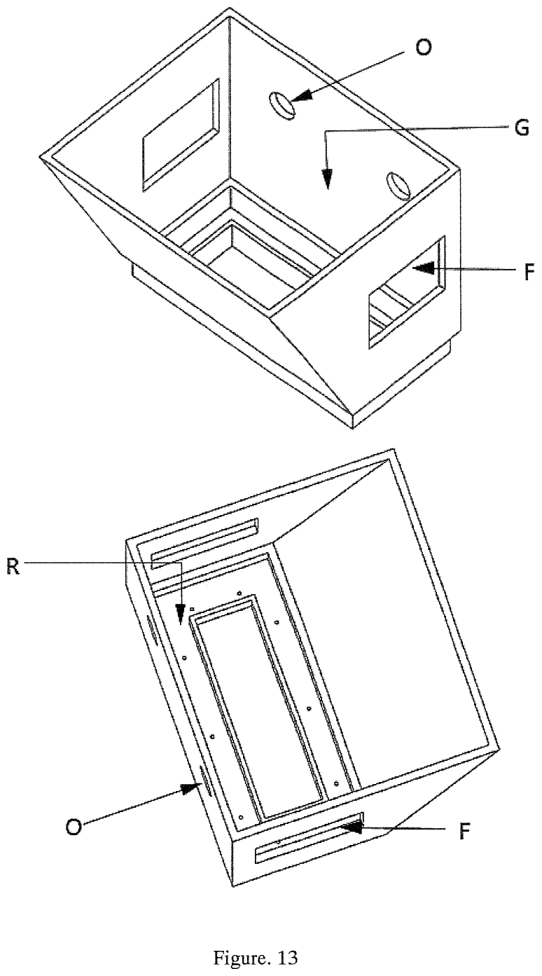

FIG. 14 The three dimension figure showing the installation of single level, single path planting panel for vertical garden (1) and single level, double path planting panel (2).

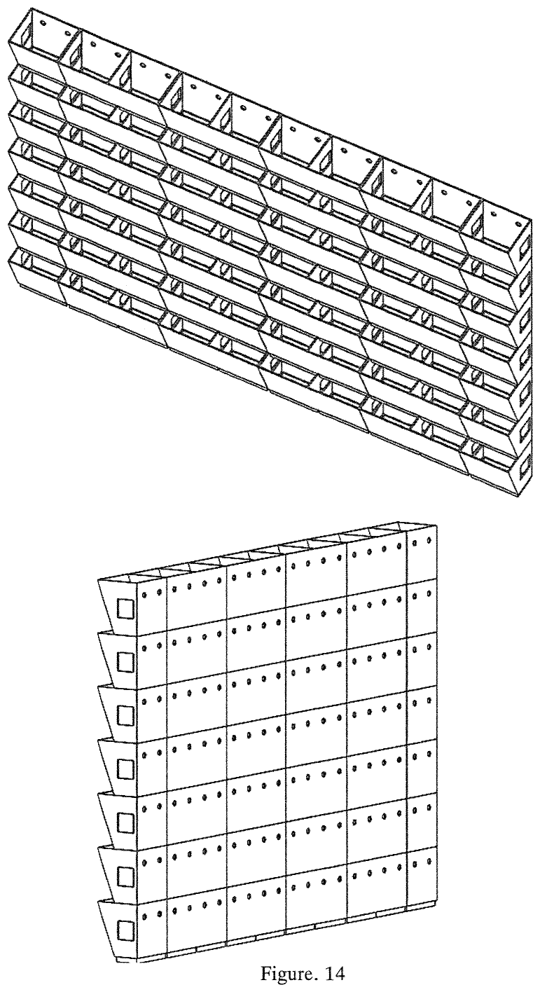

FIG. 15 The three dimension figure showing the installation of multiple level, single path plating panel for vertical garden (3) and multiple level, double path planting panel (4).

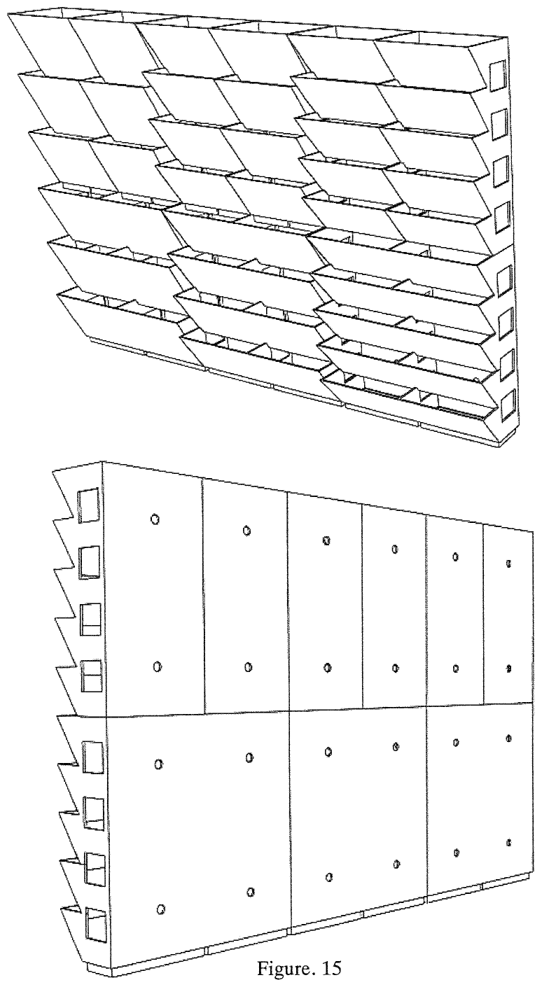

FIG. 16 The three dimension figure showing the installation of multiple level, single path planting panel for vertical garden (3) and multiple level, double path planting panel (4).

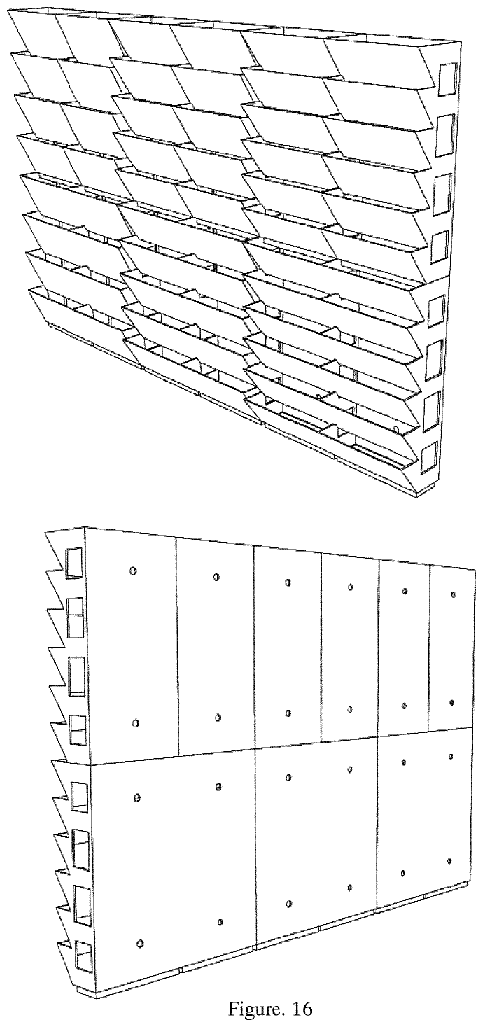

FIG. 17 The three dimension figure showing the installation to be pattern as numerical 9 of single level, single path planting panel for vertical garden (1) and water collection (6).

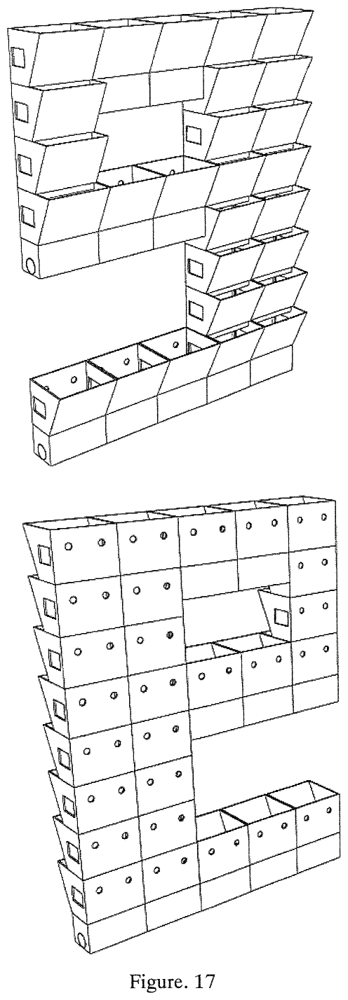

FIG. 18 The three dimension figure showing the installation of multiple level, single path planting panel for vertical garden (3) and multiple level, double path planting panel (4) soil screen box (5) and water collection (6).

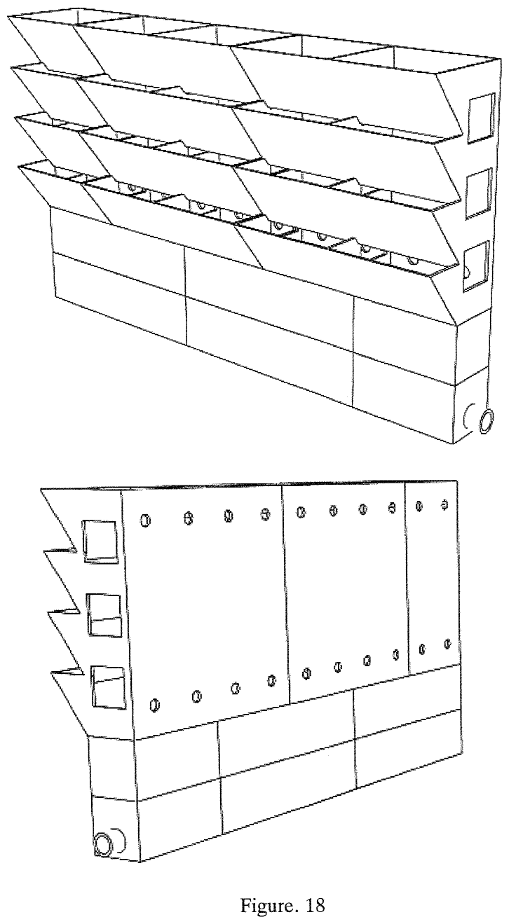

FIG. 19 The three dimension figure showing the installation of multiple level, single path planting panel for vertical garden (3) and multiple level, double path planting panel (4).

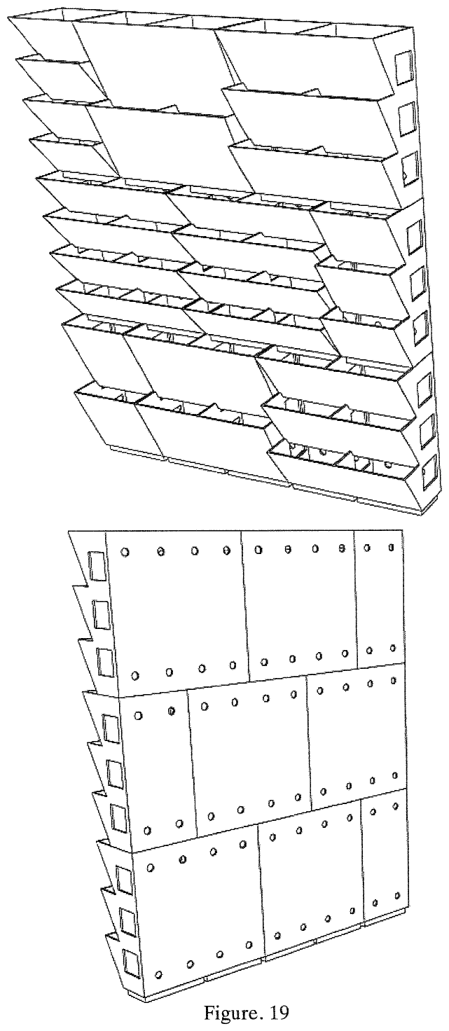

FIG. 20 The three dimension figure showing the installation of single level, single path of planting panel for vertical garden (1), single level, double path planting panel (2), multiple level, single path planting panel (3) and multiple level, double path planting panel (4).

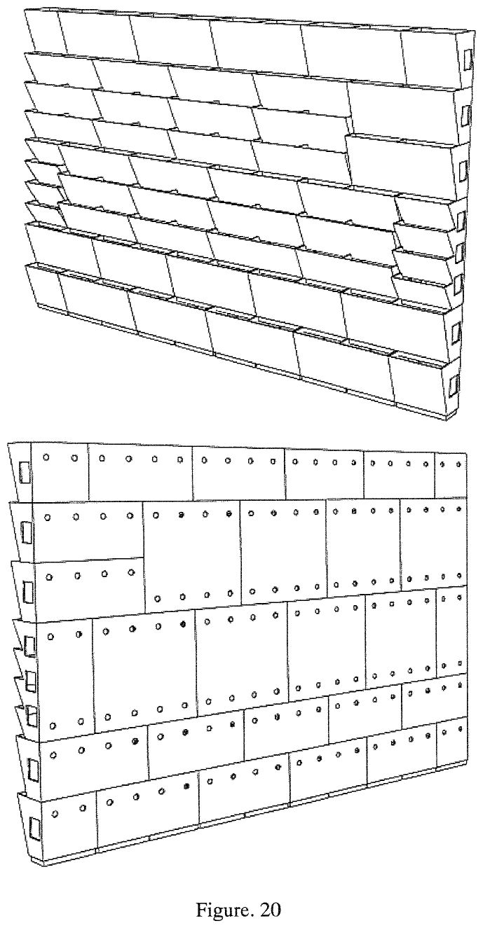

FIG. 21 The three dimension figure showing the installation of multiple level, double path planting panel for vertical garden (4).

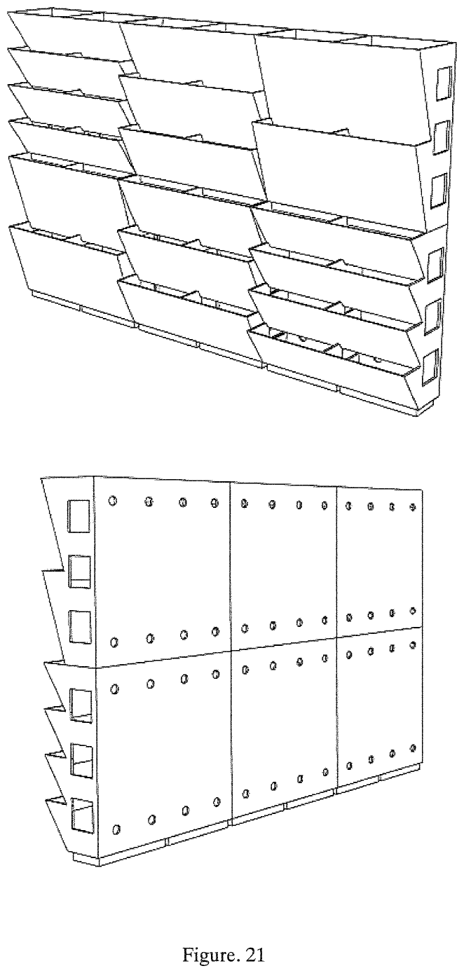

### DISCLOSURE OF INVENTION

Basic principle of the planting panel for vertical garden design. The planting panel for vertical garden and supplement equipment (1 to 11). The various description and the setting show in 1st to 21th figure. The planting panel for vertical garden is the equipment with rectangular shape and hollow inside, provide the opening at the upper (G) and lower (E). The planting path is hollow gap inside from upper through lower will have volume to keep the soil or planting materials for the plant. The planting panel for vertical garden consist of the wall 4 sides such as front, back, left and right with the central wall for double row planting channel. The upper opening is bigger than the lower opening and connecting to the volume of planting panel which overlap both the upper and the lower. The construction of vertical garden using the planting panel by constructing as overlap together, the soil inside the hollow volume of each planting panel will be connected together in vertical area liked natural ground.

The thickness of planting panel for vertical garden is the distance between the front and the back by single level planting panel for vertical garden (1, 2, 7 and 8) description show in 1st, 2nd, 7th and 8th figure. The thickness has 2 parts such as upper thickness and lower thickness. The upper thickness and lower thickness provide much different enough to have the gap for planting opening. The lower thickness is the narrowest part of planting panel for vertical garden and sufficient big for keep the soil and the root of the plant that has to grow through planting panel at the lower side. The sizing of lower thickness depend on the kind and the size of the plant. Basic principle, the lower thickness of single level planting panel should be at least 30 mm. In multiple level planting panel (3, 4, 9 and 10), description show in 3rd, 4th, 9th and 10th figure will have lower and upper thickness like as single level planting panel overlapping occasionally.

The length of planting panel for vertical garden is the distance between the right side to the left side of planting panel. The length of planting panel able to adjust the appropriate size with the plant size and size of vertical garden area. The big planting panel selected for convenience and decrease of the parts of the setting. The small planting panel use for adjust the distance appropriate size for planting area. There are 2 considerations of the length of planting panel design. The first consideration, the single path planting panel (1 and 3) which has 1 planting opening should have the length as the planting opening length. And the length of multiple path planting panel should depend on the number of horizontal planting opening. The multiple path planting panel is designed for convenience construction of vertical garden. The length of the opening or the length of single path planting panel provide 50-300 mm. Double path planting panel provide 2 times of single path planting panel provide 100-600 mm. The planting panel with 3 path has the length 3 times of single path that is 150-900 mm. But, it could adjust for the appropriation to the plant.

The height of the planting panel design should consider 2 consideration such as the height of the planting path and the height of the planting panel. The height of the planting path is the distance from lower path to upper path, which should enough height and appropriate to the size of the plant. Total height is the distance of lower to the top of planting panel. Single level planting panel (1, 2, 7 and 8) provide single path in horizontal, therefore, the height of planting panel equal to the height of planting path. Multiple level planting panel (3, 4, 9 and 10) provide multiple path overlapping as the height which has big size to facilitate the construction according to the work has less. The total height of multiple level planting panel is the summary of the height of planting path. Multiple level planting panel with the same total height, but difference in number and height of planting path is able to combine together to construct planting area with the decoration pattern as different size and different plant. Basically, the height of the path or the height of single level planting panel is between 50-300 mm., the height of multiple level planting panel has the height of the path between 50-300 mm. with 2-6 level of planting path and total height between 100-600 mm. or more.

The height of the planting path, the length and the thickness of planting panel could available by design criteria as mentioned above, the appropriate application character and type of plant. The length of multiple path planting panel and total height of multiple level planting panel able to appropriately adjust to the size of height and the length of planting area of vertical garden as the ratio with the design.

The design of planting panel provide side opening (F) both side, left and right. Single level planting panel (1, 2, 7 and 8) provide 2 sides opening. Multiple level planting panel (3, 4, 9 and 10) provide multiple sides opening which appropriately adjust to the total height of planting panel. The side opening of multiple level planting panel which have equal total height should have the same size and number of opening at the same position. Double path planting panel or multiple path planting panel provide the wall between each path and provide the size, numbering and position as the side opening. The side opening and inside opening use as the connecting of the soil in the path of planting panel in horizontal line. Watering and the root of plant is able to pass via the side opening to the adjacent planting panel. The useful of the pipe of watering or the beam or sling line or other materials hole the planting panel together or hold the planting panel with the structure. Basically, the side opening both single level and multiple level provide the width 25-100 mm and the height 25-100 mm. but, the multiple level planting panel provide 2-4 opening.

Therefore, the construction of vertical garden planting area by planting panel provide the opening connecting both the upper and the lower and the opening wall both outside and inside. The planting area with soil inside connection to other area both the vertical and horizontal line able to plant as the natural way. The root of plant has continuous growth in planting panel overlapping the lower and side without limited area. The root of plant will hole the planting panel together then the planting area has more security. The research reported that the planting area provided the root separate as good condition will produce more efficient than the limited area. Watering at top of the planting area of vertical garden, water would seep via the opening from planting panel therefore; the watering is easier than the general vertical garden.

At the side wall of planting panel both sides have another opening (N) which fit to pipe (M) of water collection (6). Water collection reserves water from above planting panels for vertical garden and transfer to the adjacent planting panel to end vertical line at any location.

The planting panel for vertical garden provide the opening of planting path (H) like the entering mouth at upper of the planting panel. The thickness of the upper planting panel has more than the lower and the upper opening has larger then lower opening. When bring the planting panel overlapping, therefore, there will be the upper opening at the front use as the planting in planting panel conveniently. The opening should has the size enough to put the plant in the planting panel easily and big enough for growing plant. Basically, every opening of planting path should provide the depth 50-150 mm. or more than.

The planting panel provide water retarding basin (R) inside, the description show in 13th figure, in order to keeping watering in the planting panel without watering frequently. The water retarding basin is able to keep the water and seep down to the lower plating panel. The water retarding basin is an internal basin as various shapes and position with small holes at the bottom to let water to seep out slowly. Basically, Single level, single row planting panel (1 and 7) provide water retarding basin 4 sides at lower wall of planting panel, the size of width, the height able to adjust to the size of planting panel and numbering of planting path, Single level, double path planting panel (2 and 8) provide 2 sets of water retarding basin. Multiple level, single path planting panel (3, 4, 9 and 10) provide the multiple of planting path received water every level or appropriate duration with the height of plating panel for the water collection.

The spur of planting panel (J) entering from lower wall of planting panel in 4 sides. The spur of planting panel use as the helping the soil in planting panel concerning the area of construction of vertical garden continuously and the soil has no leaching outside of planting panel. The holding of planting panel together, fix with soil screen box (5) and water collection (6). Spur of planting panel at the upper put in the planting panel of the lower. Single row planting panel (1, 3, 7 and 9) provide the spur put in the single planting path planting panel. Double path planting panel (2, 4, 8 and 10) provide 2 pieces of the spur equal to the spur of single path planting panel could combine as planting panel with double and single path planting panel. Also, the combination of double path planting panel able overlap with half of double planting panel or 1 path, spur of double part planting panel provide 2 parts will put in the lower 2 pieces of double path plating panel holding the horizontal line with the vertical line. The size of spur able to appropriately adjust the size of planting panel, Basically, the spur design of every model of planting panel height between 10-40 mm. but, the length and the thickness of spur must adjust for the planting panel. The planting panel provide the length and the thickness equally must provide the equal spur.

Vertical garden planting panel with fin (1) assist to protect soil movement from the opening of the path of planting panel, the description shown in 12th figure. The fin is the entering part from front wall of planting panel. The end of fin will lower than the upper opening of planting path will help to protect soil movement from the opening of planting. Both single level and multiple level of planting panel use the spur (J) which is the lowest part of planting panel and put in the lower planting panel protecting the soil movement from the opening of planting at lower position. Multiple level, single row and double row planting panel (2, 4, 8 and 10) provide the multiple level as sublevel connect fin from lower ending of front wall must be lower the opening of planting path. The fin has 2 models that are vertical fin (11) connect front wall as the vertical line as the spur and oblique fin (12) will slant the front wall. Basically, every fin provide the height 10-40 mm.

The application of clipping (11) of planting panel, description shown in 11th figure is the supplement equipment holding the side wall of planting panel together. The clipping provide the 2 legs combine together, the center provide the gap for clip the sidewall or the side opening (F) of 2 planting panel. Basically, the clipping has 20-60 mm. in width, 25-60 mm. in height. The clipping for the planting panel should be equal, the rib of outside wall of planting panel should be provide the furrow for the position determination with the planting panel. Also, the protection of clipping movement should be done. Multiple level of planting panel (3, 4, 9 and 10) provide the height and multiple level of the side opening able to use the clipping for the holding of planting panel the area of planting strongly.

The ability of planting panel apply to the construction of planting area in various garden in various place both inside and outside the building. The design of supplement equipment should be done. In order to protect soil and water move out to the lower of the planting area, and drainage the water. It able to use with the planting panel concerning the screen box (5) and water box and water collection (6).

Soil screen box (5), description shown in 5th figure is the equipment for setting the lower of planting panel protecting the soil move out at the lower of area, able to drain the water out of the planting area, the root of plant will not be root rot. Screen box is rectangular box the upper side open and the lower provide the hole for drainage. Basically, soil screen box is rectangular box the upper side open and the lower provide the hole for drainage, Basically, soil screen box has 50-100 mm. in height or more than depending on the size and the height, the depth and the length of the box. The model, size and number of the drainage hole able to adjust as the appropriately. Soil screen box provide under spur (J) as the single row and double row of planting panel connecting to water collection (6) use as the area for planting panel with screen laying. The length and the depth equally of planting panel able to use with screen box.

Water collection (6), the description shown in 6th figure is the equipment for water collection from the watering and combine to the setting water collection with the drainage system. Water collection use for the vertical garden planting area which must drain the water such as in building of the vertical garden. Water collection use in setting of planting area under soil screen box (5) or under planting panel with screen (7 to 10), description shown in planting panel with screen. The description of installation shown in 18th figure. Furthermore, the water collection can connect to the adjacent planting panel via pipe (M) through small opening with sizing as another opening (N) on side wall of planting panel. Water collection will stop water run from upper vertical line and transfer to the adjacent planting panel. It can set at some line collect he excess water from upper planting area of vertical garden of watering. Also, the construction of the plant in vertical garden, in some part and some area, no need to plant such as the tree with the arch or the decoration planting or except the door and the window or the hole of water collection. Water collection is the rectangular shape, open on the top and close at the base, the wall around the area and the side will provide the male drainage pipe (M). Also, the opposite provide female drainage pipe (N). The pipe able to connect for the drainage should be standard as same as the market standard. Basically, the male pipe has diameter 20-25 mm. distance from the box 15-50 mm. The height of the box is 50-100 mm. or more than. On the other hand, the length and the depth equal the soil screen box (5) and able to put in the spur of soil screen box and the lower spur if single hole and double hole of planting panel.

The back wall of planting panel in various types and supplement equipment (O). It able to use knot and bolt hole the planting panel with the structure or back wall. The size and numbering able to use knot and bolt hold the planting panel with the structure or back wall. The size and numbering able to appropriately adjust to the size of planting panel. Basically, the hole provide diameter of 6-10 mm.

The improvement of design of planting panel (1-4) concerning the planting panel with screen (7-10), description shown in 7th-10th figure for the setting as planting panel of planting area by no use soil screen box (5) or the planting panel with screen for the construction of planting area. The change of plating panel and still the qualification of connecting of soil in vertical garden.

The planting panel with screen consist of the component and the size as the planting panel (1-4).

From basic principle in the design of vertical garden planting panel as mentioned above able to conclude the model and size of planting panel and various equipments by the description as follows;

1. Single level, single path plating panel for vertical garden (1), the description shown as 1st figure as follows;

The planting panel provide 4 sides such as front side, back side, left side and right side.

The length measure the left to the right 50-300 mm.

The height no spur equal the height of the hole 50-250 mm.

The thickness at lower side 50-100 mm., at the top 80-200 mm , at the hole 30-100 mm.

The side opening (F) both left and right 1 opening the equal size 30-70 mm. and the height 40-100 mm.

Lower spur (J) provide equal height 10-30 mm.

Water retarding basin (R) at lower inside wall 4 sides or some side of planting panel, water retarding basin provide the width 10-30 mm The height 20-80 mm.

2. Single level, double path planting panel for vertical garden (2), description shown in 2nd figure, as follows;
Planting panel provide the length of front side 2 times of Single level, single path planting panel (1), the length 100-600 mm. approximately.
Left wall, right wall provide the size of width with side opening (F) as single level, single path planting panel (1)
Inside wall provide the size of the width with opening as the side and same position.
Planting path provide 2 paths each path the equal size as single level, single path planting panel (1)
Total height of planting panel provide size and character some as single level, single path planting panel (1)
Spur at under (J) with water retarding basin (R) 2 sets, the size and character some as single level, single path planting panel (1)

3. Multiple level, Single path vertical garden planting panel (3), description as 3rd figure as follows;
Planting panel provide front side, back side, left side and right side wall.
4 Sides of wall provide the length, depth, equal single level, single hole planting panel (1)
Front side wall divided into various walls equal the planting path.
Path planting provide 2 levels up to 6 levels in each level, the height is 50-25 mm. overlapping in vertical line and planting panel height 100-600 mm
The opening side wall 1-4 holes depend on the height of planting panel. The width 30-70 mm approximately, the height 40-100 mm. approximately as vertical line.
Water retarding basin (R) with character and size equal single path planting panel but provide 2-4 sets overlapping in vertical line. The water retarding basin depend on the opening of planting and the height of planting panel.
Fin (L) protect the soil move out at the end of lower wall except the lowest path, description shown in 12th figure.
Lower spur (J) provide the size and same character as single level, single path planting panel (1)

4. Multiple level, double path, planting panel for vertical garden (4) description shown 4th figure as follows;
Planting panel provide front wall, back wall, left wall, right wall and inside wall.
Planting panel provide the same character of multiple level, single path planting panel (3), but the size of the length provide 2 time 100-600 mm approximately.
Planting path and water retarding basin, spur, fin provide character and size equal multiple level, single path planting panel but the numbering increase 2 times.
Inside wall and the opening of wall provide same size and character as inside wall.

5. Soil screen box (5) description shown as 5th figure as follows;
Soil screen box provide the length equal single hole planting panel (1 and 3), double path planting panel (2 and 4) that is 50-60 mm.
The height of screen box able to adjust appropriately, the height 50-100 mm.
The depth provide equal the lower depth of planting panel that is 50-100 mm.
The area of drainage way at the lower (L)
The lower spur equal single level, and single path and double path planting panel (1-4)

6. Water collection box (6), description shown as 6th figure as follows;
Water collection box provide the width, depth, and height equal soil screen box (5)
Water collection box provide male pipe (M) left or right, diameter 20-50 mm., the opposite wall at same position has female pipe or hole (N) put in together.

7. Single level, single path planting path vertical garden with screen (7) description shown as 7th figure.
The description as single level, single path planting panel (1) but, provide the drainage screen as soil screen box (5) at the lower of the planting panel.

8. Single level, double path planting panel for vertical garden (8) description shown as 8th figure.
The description as single level, double path planting panel (2) provide the drainage screen as soil screen box (5) 2 sets of screen lower side of planting panel.

9. Multiple level, single path planting panel for vertical garden with screen (9) description shown as 9th figure.
The description as multiple level, single path planting panel (3) provide the drainage screen as soil article box (5) 2 sets of screen lower side of planting panel.

10. Multiple level, double path planting panel for vertical garden with screen (10) description shown as 10th figure.
The description as multiple level, double path planting panel (4) provide the drainage screen as soil screen box (5) 2 sets of screen lower side of planting panel.

11. Clipping (11) the description and the setting shown in 12th figure as follows;
Clipping provide 2 side of legs, center has path 2 times of the thickness of side material of planting panel.
Clipping provide the width 20-60 mm , the height 20-60 mm. clipping for planting panel provide the same size.
Sidewall of left side and right side of planting panel the clipping provide the furrow with the width equal the clipping.

### BEST MODE FOR CARRYING OUT THE INVENTION

The same as the mentioned in the topic completely invention disclosure.

1. A single level vertical garden planting panel (1) comprising:
a plurality of side members defining an interior portion configured to receive soil;
an upper hole (G) defined by a top edge of the plurality of side members, the upper hole having a first cross-sectional area;
a lower hole (E) defined by a bottom edge of the plurality of side members, the lower hole having a second cross-sectional area less than the first cross-sectional area;
a side hole (F) at opposing ones of the plurality of side members;
a single hole spur (J) disposed about the lower hole; and
a water retarding basin (R) operable for water collection and to delay the speed of water flow, the water retarding basis disposed at the lower hole, reducing a size of the lower hole with a shelf having one or more holes formed therethrough.

2. The single level vertical garden planting panel (2) of claim 1, further comprising:
one or more partition walls wall disposed inside the interior portion, the one or more partition walls forming two or more planting holes; and
an opening in each of the one or more partition walls, the opening providing fluid communication between each of the two or more planting holes.

3. A multiple level vertical garden planting panel (3) comprising:
a back panel;
first and second side panels extending outward from the back panel;
a plurality of front panels, each of the plurality of front panels disposed with a top edge and a bottom edge generally parallel with the back panel, the top edge spaced a first distance from the back panel that is greater than a second distance of the bottom edge from the back panel;
an upper hole (G) defined by a top edge of an upper one of the plurality of front panels, an upper edge of the first and second side panels, and the back panel, the upper hole having a first cross-sectional area, the upper hole and the bottom edge of one of the plurality of panels and a top edge of an adjacent one of the plurality of front panels each defining planting regions, each of the planting regions aligned vertically;
a lower hole (E) defined by a bottom edge of a lowest one of the plurality of front panels, the first and second side panels and the back panel, the lower hole having a second cross-sectional area less than the first cross-sectional area;
a plurality of side holes (F) at opposing locations in each of the first and second side panels for each of the planting regions;
a water retarding basin (R) operable for water collection and to delay the speed of water flow, the water retarding basis disposed at the bottom edge of each of the plurality of front panels, reducing a size of an outlet of each of the planting regions with a shelf having one or more holes formed therethrough.

4. The multiple level vertical garden planting panel (4) of claim 3, further comprising:
one or more partition walls disposed inside one or more of the planting regions, extending from the front panel to the back panel, the one or more partition walls forming two or more planting holes; and
an opening in each of the one or more partition walls, the opening providing fluid communication between each of the two or more planting holes.

5. The single level vertical garden planting panel of claim 1, further comprising a screen box (5) having an upper hole connecting to the single hole spur, the screen box having a plurality of drainage holes through a bottom portion thereof.

6. The single level vertical garden planting panel of claim 5, further comprising a water box comprising side members extending from a base member to form an upper hole, the upper hole connecting to one of the single hole spur or the screen box
wherein opposite sides of the water box has holes for connecting pipe thereto.

7-10. (canceled)

11. The single level vertical garden planting panel of claim 1, further comprising a side hole (N) in at least one of the plurality of side walls, the side hole configured to connect to a drainage pipe (M).

12. The single level vertical garden planting panel of claim 1, wherein the spur is provided in a first spur and a second spur, attached to the lower hole to provide first and second lower holes

13. The single level vertical garden planting panel of claim 12, wherein each of the first spur and the second spur having a size equal to the single hole spur when the partition wall is not present.

14. The single level vertical garden planting panel of claim 1, wherein the water retarding basin includes a first water retarding basin and a second water retarding basin.

15. The multiple level vertical garden planting panel of claim 3, further comprising a side hole (N) in at least one of the first and second of side panels, located at at least one of the planting regions, the side hole configured to connect to a drainage pipe (M).

16. The multiple level vertical garden planting panel of claim 3, further comprising a fin extending downward from the lower edge of at least one of the front panels, the fin protecting soil from move out of planting region.

17. The single level vertical garden planting panel of claim 2, further comprising a screen box (5) having an upper hole connecting to the first and second spurs, the screen box having a plurality of drainage holes through a bottom portion thereof.

18. The single level vertical garden planting panel of claim 17, further comprising a water box comprising side members extending from a base member to form an upper hole, the upper hole connecting to one of the first and second spurs or the screen box, wherein opposite sides of the water box have holes for connecting pipe thereto.

19. The multiple level vertical garden planting panel of claim 3, further comprising a screen box (5) having an upper hole connecting to the spur, the screen box having a plurality of drainage holes through a bottom portion thereof.

20. The multiple level vertical garden planting panel of claim 19, further comprising a water box comprising side members extending from a base member to form an upper hole, the upper hole connecting to one of the spur or the screen box, wherein opposite sides of the water box has holes for connecting pipe thereto.

21. The multiple level vertical garden planting panel of claim 4, further comprising a screen box (5) having an upper hole connecting to the first and second spurs, the screen box having a plurality of drainage holes through a bottom portion thereof.

22. The multiple level vertical garden planting panel of claim 4, further comprising a water box comprising side members extending from a base member to form an upper hole, the upper hole connecting to one of the first and second spurs or the screen box, wherein opposite sides of the water box has holes for connecting pipe thereto.

23. A vertical planting system comprising:
at least two planters, each of the planters comprising:
a back panel;
a first side panel extending from the back panel;
a second side panel extending from the back panel;
a front panel joining front edges of the first side panel and the second side panel, the front panel disposed with a top edge and a bottom edge generally parallel with the back panel, the top edge spaced a first distance from the back panel that is greater than a second distance of the bottom edge from the back panel;
an upper opening having a first cross-sectional area, formed from upper edges of the back panel and the front panel, between the first side panel and the second side panel;
a lower opening having a second cross-sectional area, formed from lower edges of the back panel and the front panel, between the first side panel and the second side panel; and
a planting region defined between the front panel, the back panel, the first side panel and the second side panel, wherein
each of the two planters are arranged such that an upper one of the at least two planters has its lower opening aligned with a portion of the upper opening of an adjacent lower one of the at least two planters.

24. The vertical planting system of claim 23, wherein the first side wall, the second side panel and the back panel of each of the at least two planters are, respectively, formed an a single first side panel, a single second side panel and a single back panel.
